(19) United States
(12) Patent Application Publication
(10) Pub. No.: US 2007/0057515 A1
(43) Pub. Date: Mar. 15, 2007

(54) Dual wind or hydraulic electric generating turbine

(76) Inventor: Christopher Bruce Daniels, Salem, IL (US)

Correspondence Address: CHRISTOPHER BRUCE DANIELS, 134 SOUTH LOCUST, CENTRALLA, IL, 62801, US

(21) Appl. No.: 11/216,878

(22) Filed: Sep. 1, 2005

(51) Int. Cl. F03D 9/00; H02P 9/04

(52) U.S. Cl. 290/44

(57) ABSTRACT

A wind turbine with a hydraulic motor in the nacelle configured to provide constant rotation of a generator (6). A wind turbine is connected to a generator (6) through a rotor (1), clutches (3, 9), a geared transfer case (2), and a gearbox (7). When insufficient wind is present, an electrical control box (4) signals the clutches (3, 9) to disengage and signals a hydraulic motor (5) to engage thereby rotating a gearbox (7) and a generator (6). As a result, a wind turbine is created which can produce electrical power during either wind or no wind conditions.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention is presented to solve the issue of wind generated electricity in areas, such as the Midwest in which there is wind available for a portion of the year. With this invention the generator which is increasingly more and more expensive can be utilized at closer to one hundred percent of its capacity but the alternative use of hydraulic forces which thereby offset the low wind seasons.

### BRIEF SUMMARY OF THE INVENTION

The object of this invention is to provide a wind generator which can provide wind energy during optimal wind conditions but which can also continue to provide electrical generation capability when wind conditions are not favorable. Through the use of an electrical clutch, the rotor can be disengaged allowing for a hydraulic motor to then turn the generator, thus providing constant electrical power from the generator.

### BRIEF DESCRIPTION OF THE SERVERAL VIEWS OF THE DRAWING

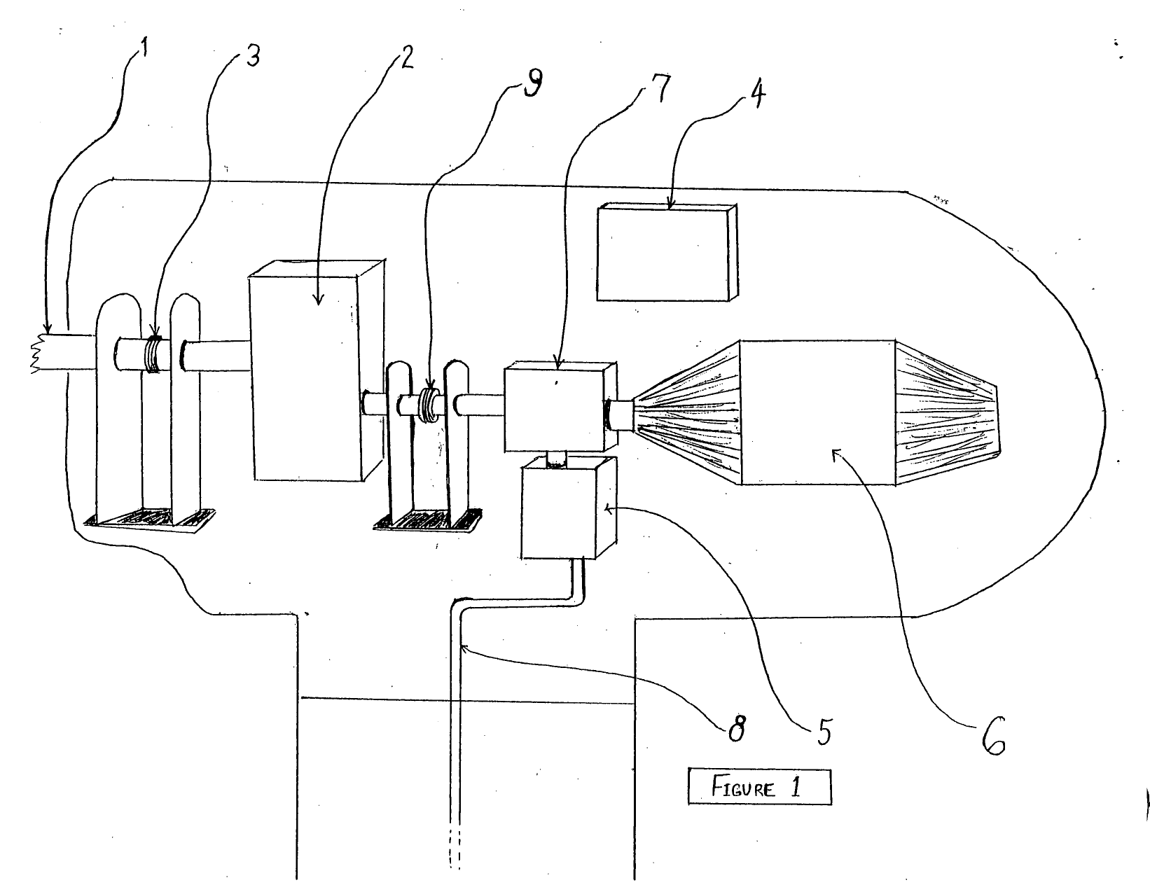

This invention has attached one drawing which is a side view of the inner workings of the nacelle housing the electric clutch, transfer case, control panel, hydraulic motor and generator. It is labeled as FIG. 1.

### DETAILED DESCRIPTION OF THE INVENTION

Free standing wind turbines are commercially dependent upon wind flows which will power them for the majority of the year. However in many areas of the country, wind studies show a flow of wind that is inconsistent or insufficient.

This invention adds to the wind turbine a hydraulic motor and clutch which gives wind field operators the option of disengaging the rotor from the generator during less than optimal wind velocity and engaging a hydraulic motor to run the generator. The source of hydraulic power to run the hydraulic pump is multiple including but not limited to a coal boiler or biomass boiler. This development will allow wind farm efficiency to increase dramatically.

What is claimed is:

1. A wind turbine with a rotor (1) separated from the transfer case (2) by a clutch (3) which, during less than optimal wind conditions, can disengage the rotor (1) from the transfer case (2), and disengage the transfer case from the gearbox (7) through a second electronic clutch (9) at the direction of the control box (4) and further cause the hydraulic motor (5), through introduction of hydraulic fluid in the hydraulic lines (8) to engage the gearbox (7) which continues to turn the generator (6) providing constant electrical generated power.
